(19) United States
(12) Patent Application Publication
(10) Pub. No.: US 2025/0201204 A1
(43) Pub. Date: Jun. 19, 2025

(54) FAIL-SAFE ARCHITECTURE FOR LOCAL DIMMING DISPLAY DEVICE

(71) Applicant: Synaptics Incorporated, San Jose, CA (US)

(72) Inventors: Takashi Nose, Kanagawa (JP); Hirobumi Furihata, Tokyo (JP); Kazutoshi Aogaki, Kanagawa (JP); Masao Orio, Tokyo (JP); Akio Sugiyama, Tokyo (JP)

(21) Appl. No.: 18/538,098

(22) Filed: Dec. 13, 2023

(51) Int. Cl. G09G 3/34; G02F 1/13357; G09G 3/36

(52) U.S. Cl. CPC G09G 3/3426; G02F 1/133602; G09G 3/3648; G09G 2320/0626; G09G 2330/12

(57) ABSTRACT

A display device that includes a backlight device and a local dimming circuit. The backlight device includes a plurality of light sources configured to illuminate a display panel. The local dimming circuit is configured to individually control luminance levels of the plurality of light sources based on first input image data in a first local dimming mode. The local dimming circuit is further configured to enter a failure mode in response to a failure of at least one of the plurality of light sources and control luminance levels of others of the plurality of light sources to a predetermined luminance level in the failure mode.

### TECHNICAL FIELD

This disclosure relates generally to display devices and more particularly to fail-safe architectures for display devices having a local dimming function.

### BACKGROUND

Panel display devices with a light-transmissive display panel (e.g., a light-transmissive liquid crystal display (LCD) panel) may include a backlight device that illuminates the light-transmissive display panel. Modern backlight devices, such as direct-lit backlights, full-array backlights etc., may be configured to illuminate a display panel with a two-dimensional (2D) array of light sources (e.g., light-emitting diodes (LEDs)). The use of a 2D light source array in a backlight device enables the implementation of a local dimming function that can achieve high dynamic contrast and low power consumption by individually controlling the respective light sources of the 2D light source array according to input image data.

### SUMMARY

This summary is intended to introduce, in a simplified form, a selection of concepts that are further described below. This summary is not necessarily intended to identify key features or essential features of the present disclosure. The present disclosure may include the following various aspects and embodiments.

In an exemplary embodiment, the present disclosure provides a display device that includes a backlight device and a local dimming circuit. The backlight device includes a plurality of light sources configured to illuminate a display panel. The local dimming circuit is configured to individually control luminance levels of the plurality of light sources based on first input image data in a first local dimming mode. The local dimming circuit is further configured to enter a failure mode in response to a failure of at least one of the plurality of light sources and control luminance levels of others of the plurality of light sources to a predetermined luminance level in the failure mode.

In another exemplary embodiment, the present disclosure provides a display driver that includes a local dimming circuit and a driver circuit. The local dimming circuit is configured to individually control luminance levels of a plurality of light sources of a backlight device based on first input image data in a first local dimming mode. The plurality of light sources are configured to illuminate a display panel. The local dimming circuit is further configured to enter a failure mode in response to a failure of at least one of the plurality of light sources and control luminance levels of others of the plurality of light sources to a predetermined luminance level in the failure mode. The driver circuit is configured to drive the display panel based on the first input image data.

In yet another exemplary embodiment, the present disclosure provides a method. The method includes placing a local dimming circuit into a first local dimming mode. The method further includes individually controlling, by the local dimming circuit in the first local dimming mode, luminance levels of a plurality of light sources of a backlight device based on first input image data. The method further includes placing the local dimming circuit in a failure mode in response to a failure of at least one of the plurality of light sources. The method further includes controlling, by the local dimming circuit in the failure mode, luminance levels of others of the plurality of light sources to a predetermined luminance level.

Other features and aspects are described in more detail below with reference to the attached drawings.

### BRIEF DESCRIPTION OF THE DRAWINGS

FIG. 1 shows an example configuration of a display device, according to one or more embodiments.

FIG. 2 shows an example arrangement of light sources of a backlight device, according to one or more embodiments.

FIG. 3 shows an example configuration of a local dimming circuit, according to one or more embodiments.

FIG. 4 shows an example of a compensated gamma curve determined for pixels located in a zone corresponding to a failed light source, according to one or more embodiments.

FIG. 5 is a flowchart showing an example method, according to one or more embodiments.

FIG. 6 shows an example configuration of a display device, according to other embodiments.

FIG. 7A shows an example of light source failure compensation, according to one or more embodiments.

FIG. 7B shows another example of light source failure compensation, according to one or more embodiments.

FIG. 8A shows an example configuration of a local dimming circuit, according to one or more embodiments.

FIG. 8B shows an example configuration of a backlight control circuit, according to one or more embodiments.

FIG. 9 is a flowchart showing an example method, according to one or more embodiments.

FIG. 10 shows an example of average picture levels (APLs) of respective zones of a display panel, according to one or more embodiments.

FIG. 11 shows an example of zone corner APLs determined for respective zone corners, according to one or more embodiments.

FIG. 12 shows an example calculation of a pixel APL for a pixel, according to one or more embodiments.

FIG. 13 shows an example relationship between gamma values and pixel APLs, according to one or more embodiments.

FIG. 14 shows an example use of a hypothetical APL for a zone corresponding to a failed light source, according to one or more embodiments.

For ease of understanding, where possible, identical reference numerals have been used, to designate elements that are common to the figures. It is contemplated that elements disclosed in one embodiment may be used in other embodiments without specific recitation. Suffixes may be appended to reference numerals to distinguish elements from one another. The drawings referenced herein are not be to be construed as being drawn to scale unless specifically noted. In addition, the drawings are often simplified and details or components are omitted for clarity of presentation and explanation. The drawings and discussion serve to explain principles discussed below.

### DETAILED DESCRIPTION

The following detailed description is exemplary in nature and is not intended to limit the disclosure or the applications and uses of the disclosure. Further, there is no intention to be bound by any expressed or implied theory presented in the preceding background, summary and brief description of the drawings, or in the following detailed description. In the following detailed description, numerous specific details are set forth in order to provide a more thorough understanding of the disclosed technology. However, it will be apparent to one of ordinary skill in the art that the disclosed technology may be practiced without these specific details. In other instances, well-known features have not been described in detail to avoid unnecessarily complicating the description.

The term “coupled” as used herein means connected directly to or connected through one or more intervening components or circuits. Further, throughout the application, ordinal numbers (e.g., first, second, third, etc.) may be used as an adjective for an element (i.e., any noun in the application). The use of ordinal numbers is not intended to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Panel display devices with a light-transmissive display panel (e.g., a light-transmissive liquid crystal display (LCD) panel) may include a backlight device configured to illuminate a display panel with a two-dimensional (2D) array of light sources (e.g., light-emitting diodes (LEDs)). The use of a 2D light source array in a backlight device enables the implementation of a local dimming function that can achieve high dynamic contrast and low power consumption by individually controlling the respective light sources of the 2D light source array according to input image data.

In actual use, one or more light sources of a backlight device may fail due to aging, mechanical and/or electrical shock, or other causes. Because a failed light source may not emit light as desired, the failure of one or more light sources may result in partial loss of display on the display panel, which may cause inconvenience to the user of the display device. In addition, in some circumstances, such as automotive applications, it may be desirable to avoid partial loss of display for safety reasons.

The present disclosure provides various technologies for avoiding partial loss of display potentially caused by failure of one or more light sources of the backlight device. In one or more embodiments, a display device includes a backlight device and a local dimming circuit. The backlight device includes a plurality of light sources configured to illuminate a display panel. The local dimming circuit is configured to individually control luminance levels of the plurality of light sources based on first input image data in a first local dimming mode. The local dimming circuit is further configured to enter a failure mode in response to a failure of at least one of the light sources and control luminance levels of others of the plurality of light sources to a predetermined luminance level in the failure mode. In one implementation, the predetermined luminance level may be a maximum allowed luminance level for the plurality of light sources. The following describes detailed embodiments for avoiding partial loss of display potentially caused by failure of one or more light sources of the backlight device.

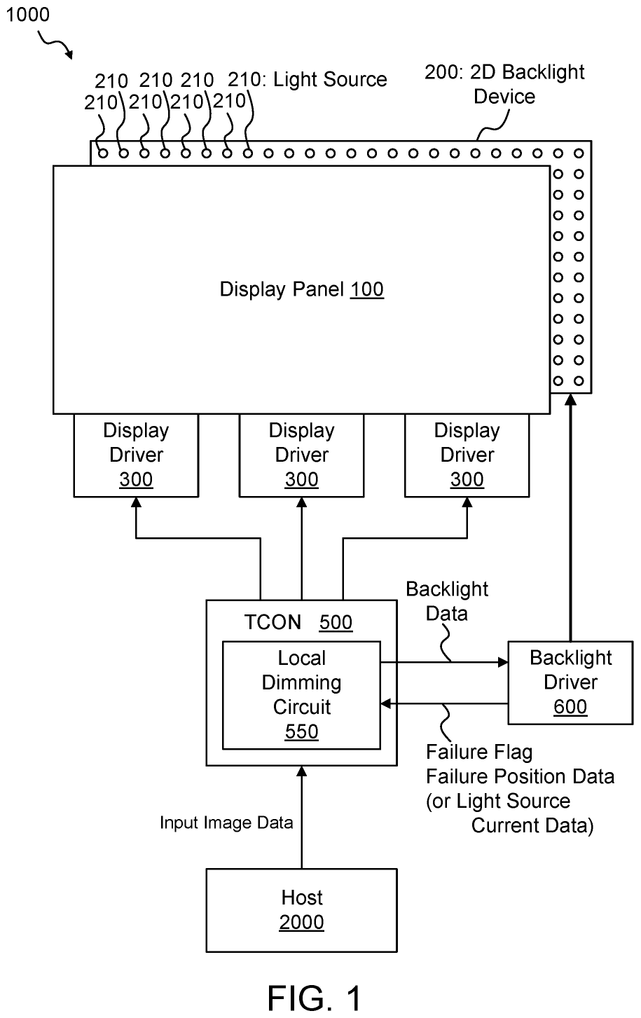

FIG. 1 shows an example configuration of a display device 1000, according to one or more embodiments. In the shown embodiment, the display device 1000 includes a display panel 100, a two-dimensional (2D) backlight device 200, a plurality of display drivers 300, a timing controller (TCON) 500, and a backlight driver 600. The display panel 100 may be a light-transmissive display panel such as a liquid crystal display (LCD) panel. The 2D backlight device 200 is located behind the display panel 100 to illuminate the display panel 100. The 2D backlight device 200 includes an array of light sources 210 configured to illuminate corresponding zones of the display panel 100. In one implementation, each light source 210 may include a light emitting diode (LED) or other type of light source.

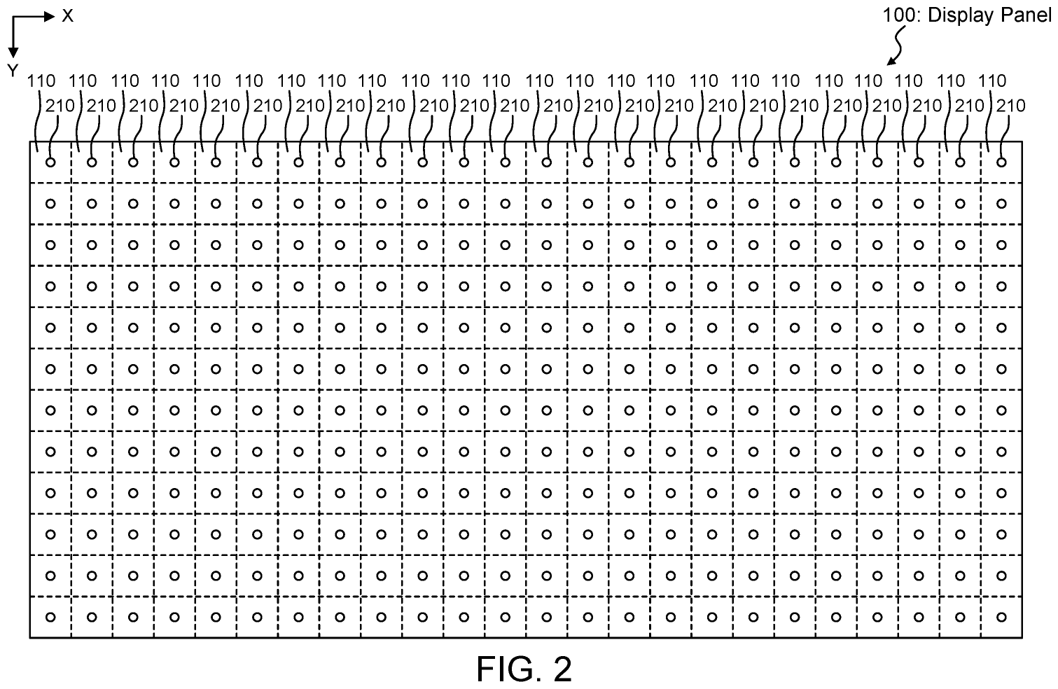

FIG. 2 shows an example arrangement of the light sources 210 of the backlight device 200, according to one or more embodiments. Hereinafter, directions may be indicated by the X and Y axes, where the X axis is oriented in the horizontal direction of the display panel 100 and the Y axis is oriented in the vertical direction of the display panel 100. In the shown embodiment, the display panel 100 is segmented into an array of zones 110, and the light sources 210 are arranged such that the projections of the respective light sources 210 onto the display panel 100 are located at the centers (e.g., the geometric centers) of the corresponding zones 110. Because the light emitted from each light source 210 spreads out as it travels, each light source 210 is configured to primarily illuminate the corresponding zone 110, but secondarily illuminate adjacent zones 110 around the corresponding zone 110. In one implementation, the zones 110 have a rectangular (e.g., square) shape and are arranged in rows and columns. In other implementations, the zones 110 may have a different shape, such as a rhombic shape and a hexagonal shape, as long as the zones 110 completely cover the display panel 100. While 288 light sources 210 are shown in FIG. 2, those skilled in the art would appreciate that the 2D backlight device 200 may include more or less than 288 light sources 210. In actual implementations, the 2D backlight device 200 may include from several hundred to several thousand light sources 210.

Referring back to FIG. 1, the display drivers 300 are configured to drive or update the display panel 100 under the control of the timing controller 500. In the shown embodiments, the display device 1000 includes three display drivers 300, the leftmost of which is configured to drive the left one-third of the display panel 100, the middle of which is configured to drive the middle one-third, and the rightmost of which is configured to drive the right one-third.

The timing controller 500 is configured to receive input image data from a host 2000 and control the display drivers 300 to display the image corresponding to the input image data on the display panel 100. In one implementation, the input image data includes graylevels of respective pixels of the display panel 100. The host 2000 may be an application processor, a central processing unit (CPU), or any other type of processor configured to generate the input image data. The host may include non-transitory memory to store data. The timing controller 500 is further configured to provide timing control of the display drivers 300 during image display on the display panel 100. In some implementations, the timing controller 500 may be configured to provide horizontal synchronization and vertical synchronization for the display drivers 300 to display consistent images on the display panel 100.

In the shown embodiment, the timing controller 500 includes a local dimming circuit 550 configured to generate and provide backlight data to the backlight driver 600 to achieve a local dimming function that individually controls the luminance levels of the light sources 210 of the 2D backlight device 200. In some implementations, the backlight data may include backlight values for the respective light sources 210 and the backlight driver 600 may be configured to control the light sources 210 based on the backlight data. In one implementation, the backlight values for the respective light sources 210 may indicate specified luminance levels of the light sources 210, and the backlight driver 600 may be configured to control the luminance levels of the respective light sources 210 as specified by the backlight values.

In some implementations, the local dimming circuit 550 may be further configured to process the input image data to generate processed image data and provide the processed image data to the display drivers 300. In such implementations, the display drivers 300 may be configured to drive the display panel 100 based on the processed image data.

In one or more embodiments, the local dimming circuit 550 is further configured to implement a fail-safe function in the event of a failure of one or more light sources 210. The local dimming circuit 550 is configured to enter a failure mode in response to a failure of at least one of the light sources 210. The local dimming circuit 550 is further configured to, in the failure mode, control the luminance levels of other light sources 210 to a predetermined sufficiently high luminance level so that the zone(s) 110 corresponding to the failed light source(s) 210 is illuminated by the light sources 210 adjacent to the failed light source(s) 210. This allows the user to visually perceive the portion of the image to be displayed in the zone(s) 110 corresponding to the failed light source(s) 210, thereby avoiding a partial loss of display on the display panel 100. In one implementation, the predetermined luminance level may be the maximum allowed luminance level for the light sources 210 to illuminate the zone(s) 110 corresponding to the failed light source(s) 210 as brightly as possible by the adjacent light sources 210. In other implementations, the predetermined luminance level may be other than the maximum allowed luminance level for the light sources 210.

To implement the fail-safe function, in some embodiments, the backlight driver 600 may be configured to detect a failure of one or more light sources 210 of the backlight device 200 and send a failure flag to the local dimming circuit 550 in response to detecting the failure. In such embodiments, the local dimming circuit 550 may be configured to enter the failure mode in response to receiving the failure flag from the backlight driver 600. The backlight driver 600 may further be configured to send failure position data to the local dimming circuit 550. The failure position data may indicate the position(s) or arrangement of the failed light source(s) 210. In such embodiments, the local dimming circuit 550 may be configured to enter the failure mode depending on the number of the failed light source(s) 210. In one implementation, the local dimming circuit 550 may be configured to enter the failure mode in response to the number of the failed light sources 210 exceeding a predetermined threshold number. In alternative embodiments, the backlight driver 600 may be configured to measure the current levels of the respective light sources 210 (i.e., the levels of currents supplied to the respective light sources 210) and provide light source current data indicative of the current levels of the respective light sources 210. In such embodiments, the local dimming circuit 550 may be configured to determine the number of the failed light source(s) 210 based on the light source current data and enter the failure mode in response to the number of the failed light sources 210 exceeding a predetermined threshold number.

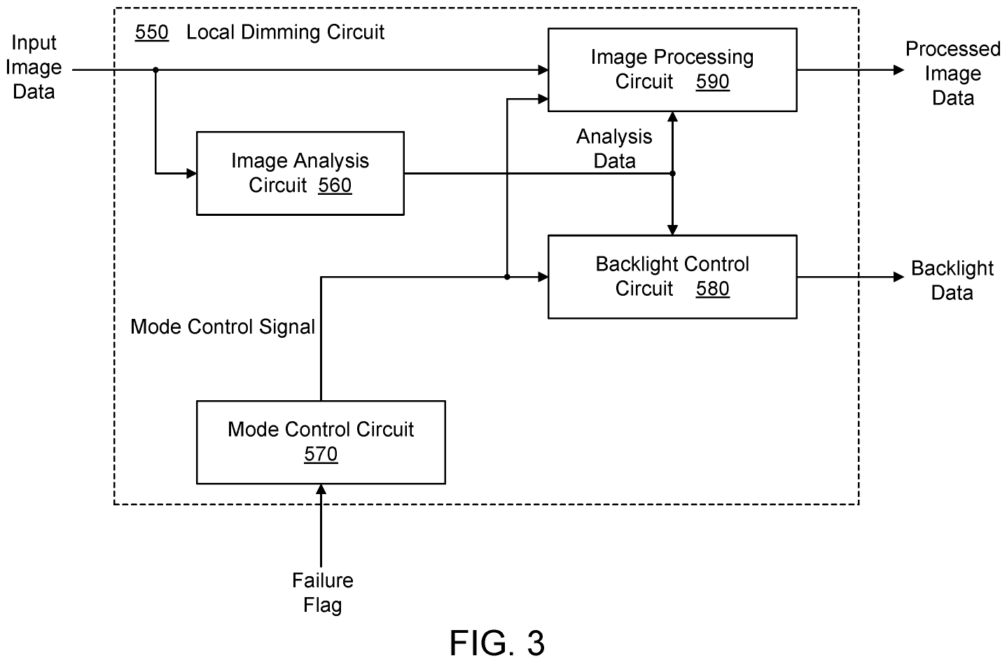

FIG. 3 shows an example configuration of the local dimming circuit 550, according to one or more embodiments. In the shown embodiment, the local dimming circuit 550 is configured to receive the input image data from the host 2000 (shown in FIG. 1) and the failure flag from the backlight driver 600. The local dimming circuit 550 is configured to process the input image data to generate processed image data and further generate the backlight data to control the luminance levels of the respective light sources 210 of the backlight device 200. In one or more embodiments, the local dimming circuit 550 includes an image analysis circuit 560, a mode control circuit 570, a backlight control circuit 580, and an image processing circuit 590.

The image analysis circuit 560 is configured to analyze the input image data to generate analysis data. In one implementation, the image analysis circuit 560 may be configured to calculate average picture levels (APLs) of the respective zones 110 of the display panel 100 based on the input image data, and the analysis data may include the APLs of the respective zones 110.

The mode control circuit 570 is configured to control the operating mode of the local dimming circuit 550 in response to the failure flag received from the backlight driver 600 (shown in FIG. 1). In one or more embodiments, the mode control circuit 570 may be configured to, in response to not receiving the failure flag, place the local dimming circuit 550 in a local dimming mode in which the local dimming function is implemented. The mode control circuit 570 may further be configured to, in response to reception of the failure flag from the backlight driver 600, place the local dimming circuit 550 in the failure mode in which the local dimming function is stopped. The mode control circuit 570 may further be configured to generate a mode control signal indicative of the operating mode of the local dimming circuit 550 (e.g., the local dimming mode, the failure mode or other operating modes, if any) to the backlight control circuit 580 and the image processing circuit 590.

The backlight control circuit 580 is configured to generate the backlight data, which may include the backlight values that control the luminance levels of the respective light sources 210. The generation of the backlight data is based on the operating mode informed by the mode control signal. When the mode control signal indicates that the local dimming circuit 550 is in the local dimming mode, the backlight control circuit 580 generates the backlight data based on the analysis data received from the image analysis circuit 560 to achieve the local dimming function. In implementations where the analysis data includes the APLs of the respective zones 110 of the display panel 100 and the backlight data includes backlight values for the respective light sources 210, the backlight control circuit 580 may be configured to determine the backlight values for the respective light sources 210 based on the APLs of the zones 110 corresponding to the respective light sources 210.

When the mode control signal indicates that the local dimming circuit 550 is in the failure mode, the backlight control circuit 580 stops the local dimming function and generates the backlight data to control the non-failed light sources 210 (i.e., the light sources 210 other than the failed light source(s) 210) to a predetermined sufficiently high luminance level. This allows the light sources 210 surrounding the failed light source(s) 210 to illuminate the zone(s) 110 corresponding to the failed light source(s) 210. In one implementation, when the local dimming circuit 550 is in the failure mode, the backlight control circuit 580 may determine the backlight values for the non-failed light sources 210 contained in the backlight data to be the value corresponding to the maximum allowed luminance level to cause the non-failed light sources 210 to emit light at the maximum allowed luminance level.

The image processing circuit 590 is configured to process the input image data based on the analysis data to generate processed image data. The processed image data is provided to the display drivers 300, which are configured to drive the display panel 100 based on the processed image data. The image processing performed by the image processing circuit 590 may include a gamma transformation. In one implementation, the gamma transformation may convert input graylevels to gamma-transformed graylevels for the respective pixels in accordance with gamma curves determined for the respective pixels based on the APLs described in the analysis data. The gamma curve referred to herein is a curve representing the correspondence between the input graylevel and the gamma-transformed graylevel in the gamma transformation. The input greylevels of the respective pixels may be generated by performing desired processing (e.g., color adjustment, demura correction, deburn correction, image scaling, or other image processes) on the greylevels of the respective pixels described in the input image data. In alternative implementations, the greylevels described in the input image data may be used as the input greylevels without modification. The gamma-transformed graylevels of the respective pixels are used to determine the graylevels of the respective pixels described in the processed image data. In one implementation, the gamma-transformed graylevels determined by the gamma transformation may be used without modification as the graylevels described in the processed image data. In one or more embodiments, the gamma value of the gamma curve used for the gamma transformation may be determined for each pixel in each zone 110 based on the APL of that zone 110. It should be noted that, as is known in the art, the gamma value is a parameter that defines the shape of the gamma curve of interest. The processing performed by the image processing circuit 590 may further include various image processes other than the gamma transformation, such as color adjustment, demura correction, deburn correction, image scaling, or other image processes.

In one or more embodiments, the image processing circuit 590 may be further configured to determine, in response to the local dimming circuit 550 entering the failure mode, a compensated gamma curve for pixels located in the zone(s) 110 corresponding to the failed light source(s) 210 to increase the luminance levels of the pixels in that zone 110. In such embodiments, the image processing circuit 590 may be configured to perform a gamma transformation on the input greylevels of the pixels located in the zone(s) 110 corresponding to the failed light source(s) 210 in accordance with the compensated gamma curve.

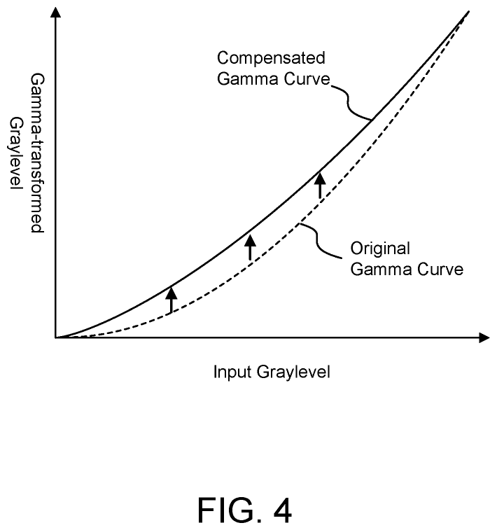

FIG. 4 shows an example of a compensated gamma curve determined for pixels located in a zone 110 corresponding to a failed light source 210, according to one or more embodiments. The solid curve indicates the compensated gamma curve, while the dashed curve indicates an original gamma curve determined based on the APL of the zone 110 corresponding to the failed light source 210 as in the local dimming mode. The compensated gamma curve is determined such that the gamma value of the compensated gamma curve is less than the gamma value of the original gamma curve. In one implementation, the compensated gamma curve may be determined such that the gamma value of the compensated gamma curve is a predetermined value equal to or close to 1.0. It should be noted that while the default gamma value of a commonly used display device is 2.2, and the gamma value of 1.0 represents a linear correlation between the input graylevel and the gamma-transformed graylevel. The gamma value of the compensated gamma curve may be determined to be substantially less than 2.2. Using the compensated gamma curve determined in this way effectively increases the luminance levels of the pixels located in the zone 110 corresponding to the failed light source 210.

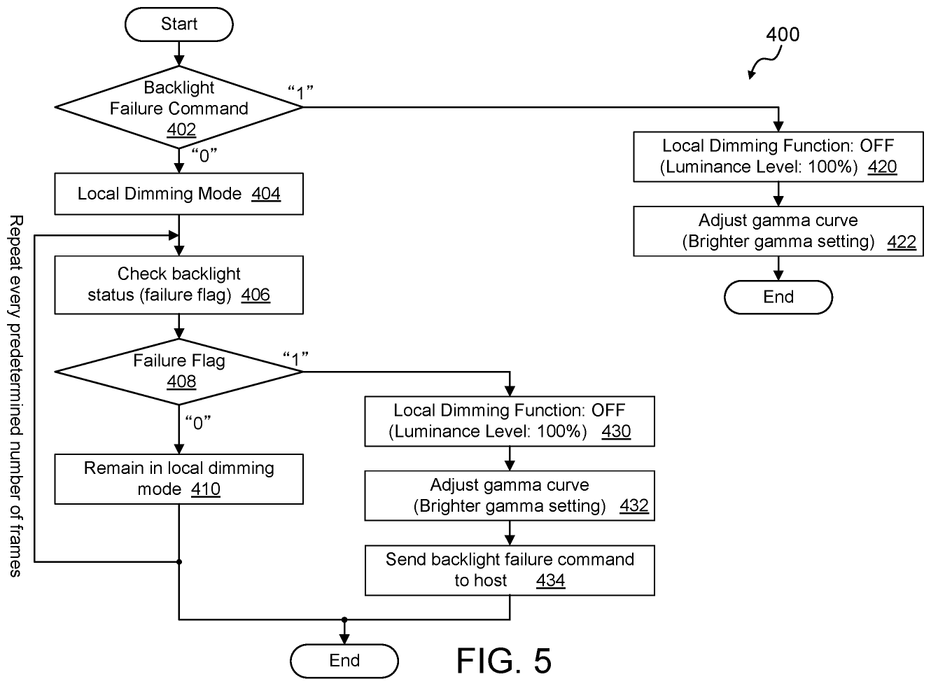

FIG. 5 is a flowchart showing an example method 400 that implements a fail-safe function for avoiding partial loss of display when a failure of one or more light sources 210 occurs, according to one or more embodiments. It will be recognized that any of the following steps may be performed in any suitable order and that the method 400 may be performed in any suitable environment.

In some implementations, the host 2000 (shown in FIG. 1) may have information regarding the failure of the light sources 210 of the backlight device 200 prior to the startup of the display device 1000. Upon startup of the display device 1000, the host 2000 may send a backlight failure command to the local dimming circuit 550 of the timing controller 500 if the host 2000 is aware that one or more light sources 210 have failed. If the local dimming circuit 550 receives the backlight failure command from the host 2000 during startup in step 402 (i.e., if one or more light sources 210 have failed), the process proceeds to step 420.

In step 420, the local dimming circuit 550 enters the failure mode, thereby disabling the local dimming function. Further, the backlight control circuit 580 of the local dimming circuit 550 adjusts the luminance levels of the non-failed light sources 210 to a predetermined luminance level, e.g., 100% or the maximum allowed luminance level, by the backlight data. In one implementation, the backlight control circuit 580 may determine the backlight values for the non-failed light sources 210 contained in the backlight data to be the value corresponding to the maximum allowed luminance level to cause the non-failed light sources 210 to emit light at the maximum allowed luminance level. The process then proceeds to step 422.

In step 422, the image processing circuit 590 of the local dimming circuit 550 adjusts the gamma curve used for the gamma transformation for the pixels located in the zone(s) 110 corresponding to the failed light source(s) 210. In one implementation, the image processing circuit 590 determines a compensated gamma curve for the pixels located in the zone(s) 110 corresponding to the failed light source(s) 210 and performs the gamma transformation for the pixels located in the zone(s) 110 corresponding to the failed light source(s) 210 in accordance with the compensated gamma curve. As discussed in relation to FIG. 4, the compensated gamma curve may be determined such that the gamma value of the compensated gamma curve is a predetermined value equal to or close to 1.0 to increase the luminance levels of the pixels located in the zone(s) 110 corresponding to the failed light source(s) 210.

When the local dimming circuit 550 does not receive the backlight failure command during the startup in step 402, the local dimming circuit 550 enters the local dimming mode in step 404. In the local dimming mode, the backlight control circuit 580 performs the local dimming function to individually control the luminance levels of the respective light sources 210 of the backlight device 200 based on the analysis data received from the image analysis circuit 560. The process then proceeds to step 406.

In step 406, the local dimming circuit 550 checks the status of the backlight device 200 based on whether the local dimming circuit 550 receives the failure flag from the backlight driver 600. The local dimming circuit 550 remains in the local dimming mode in step 410 as long as the local dimming circuit 550 does not receive the failure flag. The local dimming circuit 550 may check the status of the backlight device 200 every predetermined number of frames as long as the local dimming circuit 550 remains in the local dimming mode. Alternatively, the local dimming circuit 550 may check the status of the backlight device 200 at predetermined time intervals and/or periodically as long as the local dimming circuit 550 remains in the local dimming mode.

When a failure of one or more light sources 210 occurs during operation, the backlight driver 600 sends the failure flag to the local dimming circuit 550 in step 408, and the process proceeds to step 430.

In step 430, the local dimming circuit 550 enters the failure mode, thereby disabling the local dimming function. In addition, the backlight control circuit 580 of the local dimming circuit 550 adjusts the luminance levels of the non-failed light sources 210 to a predetermined luminance level (e.g., 100% or the maximum allowed luminance level) by the backlight data as in step 420. The process then proceeds to step 432.

In step 432, the image processing circuit 590 of the local dimming circuit 550 adjusts the gamma curve used for the gamma transformation for the pixels located in the zone(s) 110 corresponding to the failed light source(s) 210 as in step 422. In one implementation, the image processing circuit 590 determines a compensated gamma curve for the pixels located in the zone(s) 110 corresponding to the failed light source(s) 210 and performs the gamma transformation for the pixels located in the zone(s) 110 corresponding to the failed light source(s) 210 in accordance with the compensated gamma curve. As discussed in relation to step 422, the compensated gamma curve may be determined such that the gamma value of the compensated gamma curve is a predetermined value equal to or close to 1.0 to increase the luminance levels of the pixels located in the zone(s) 110 corresponding to the failed light source(s) 210. The process then proceeds to step 434.

In step 434, the local dimming circuit 550 sends a backlight failure command to the host 2000 to thereby notify the host 2000 of the occurrence of the failure of one or more light sources 210. This causes the host 2000 to be aware of the failure of one or more light sources 210. At the next startup of the display device 1000, the host 2000 may send a backlight failure command to the local dimming circuit 550 to notify the local dimming circuit 550 of the failure of one or more light sources 210.

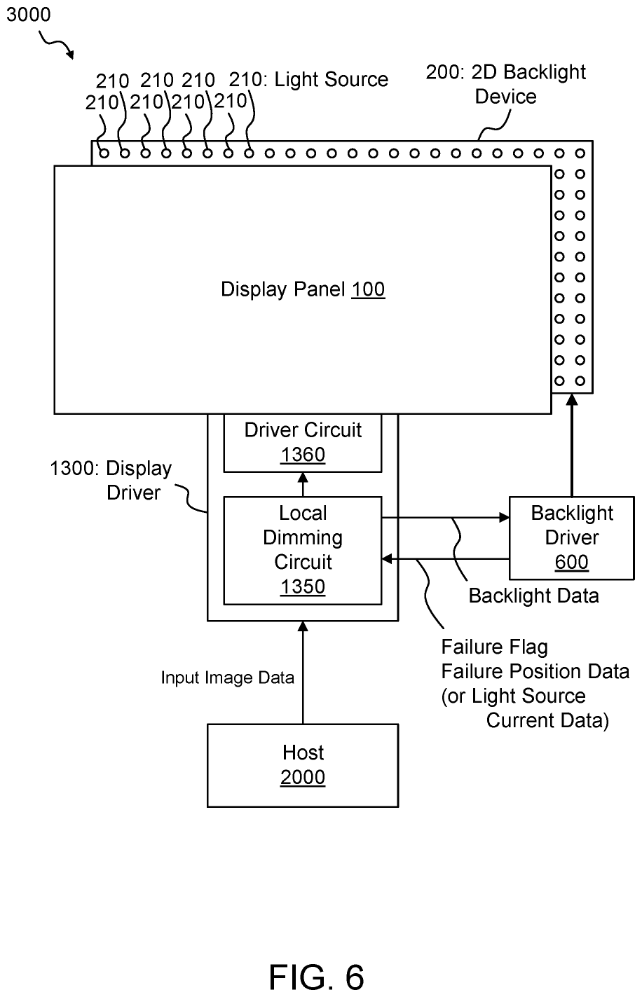

FIG. 6 shows an example configuration of a display device 3000, according to other embodiments. In the shown embodiment, a local dimming circuit 1350 is integrated into a display driver 1300 configured to drive the display panel 100. The local dimming circuit 1350 may be configured similarly to the local dimming circuit 550 shown in FIGS. 1 and 3, and may operate similarly to the local dimming circuit 550. The local dimming circuit 1350 may be configured to generate and provide the backlight data to the backlight driver 600. The local dimming circuit 1350 may further be configured to provide the processed image data to a driver circuit 1360. The driver circuit 1360 may be configured to drive the display panel 100 based on the processed image data.

While the method 400 shown in FIG. 5 disables the local dimming function in response to a failure of one or more light sources, the present disclosure recognizes that a failure of a small number of light sources 210 (e.g., one light source 210) may be compensated for by increasing the luminance levels of the light sources adjacent to the failed light sources, particularly in embodiments where the light sources 210 are spaced at relatively small intervals. In embodiments where the failure of a small number of the light sources 210 is compensated for by increasing the luminance levels of the adjacent light sources 210, the local dimming function may be implemented regardless of the occurrence of such light source failure.

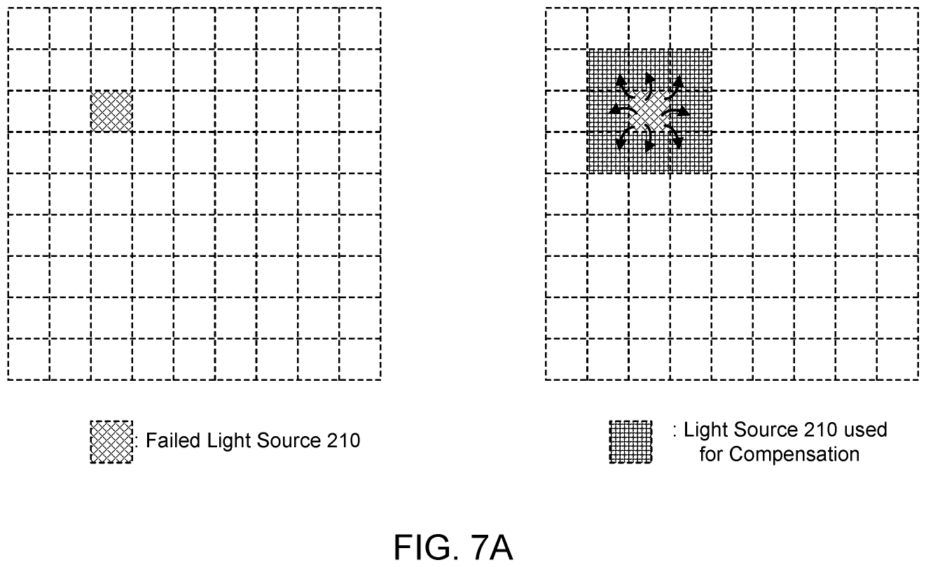

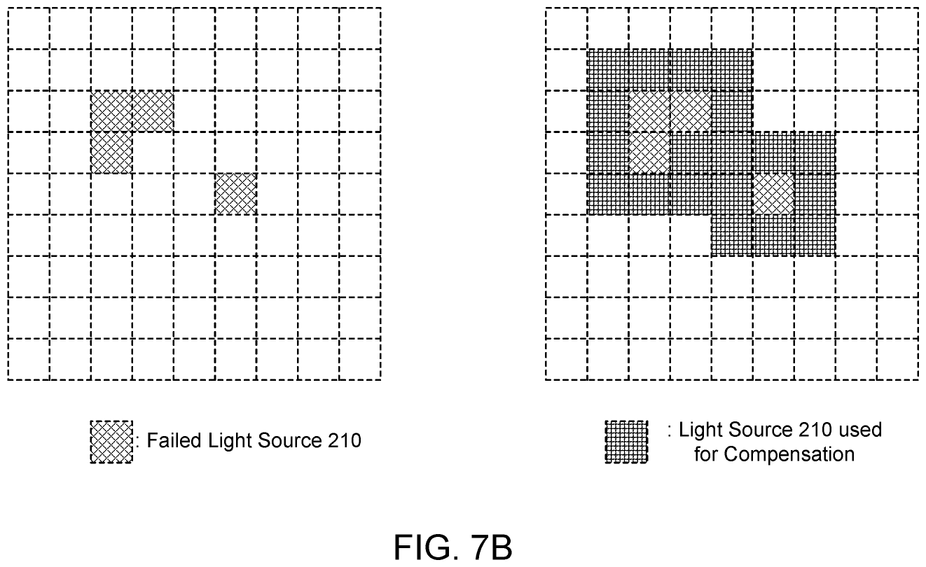

FIG. 7A shows an example of light source failure compensation, according to one or more embodiments. In the shown example, one light source 210, indicated by diagonal cross-hatching, is experiencing a failure. In this case, in one or more embodiments, the failure of this light source 210 may be compensated by increasing the luminance levels of the eight light sources 210 adjacent to the failed light source 210. The light sources 210 used for the compensation are indicated by vertical and horizontal hatching in FIG. 7A.

FIG. 7B shows another example of light source failure compensation, according to one or more embodiments. In the shown example, four light sources, indicated by diagonal cross-hatching, is experiencing a failure. Also in this case, the failure of the four light sources may be compensated by increasing the luminance levels of the nineteen light sources adjacent to the four failed light sources. The light sources used for the compensation are indicated by vertical and horizontal hatching in FIG. 7B.

In one implementation, the luminance levels of the light sources 210 adjacent to at least one failed light source 210 may be controlled as follows. First, a base backlight value for each light source 210 may be determined based on the input image data. In one implementation, the base backlight value for each light source 210 may be determined based on the APL of the zone corresponding to that zone. It is noted that the APL of each zone may be calculated based on the input image data. This is followed by determining compensated backlight values for the light sources 210 adjacent to the at least one failed light source 210 based on the base backlight values for the light sources 210 adjacent to the failed light source 210 and the failure position data, which indicates the position or arrangement of the at least one failed light source 210. The compensated backlight values for the light sources 210 adjacent to the at least one failed light source 210 may be determined by modifying the base backlight values of the adjacent light sources 210 based on the failure position data. In one implementation, compensation coefficients that may indicate the amounts by which the luminance levels of the adjacent light sources 210 are to be increased are determined based on the failure position data, and the compensated backlight values of the adjacent light sources 210 may be determined by applying the compensation coefficients to the respective base backlight values of the adjacent light sources 210. The compensated backlight values of the light sources 210 adjacent to the failed light source 210 may indicate specified luminance levels of the adjacent light sources 210. The light sources 210 adjacent to the failed light source 210 may be controlled based on the compensated backlight values determined for those adjacent light sources 210.

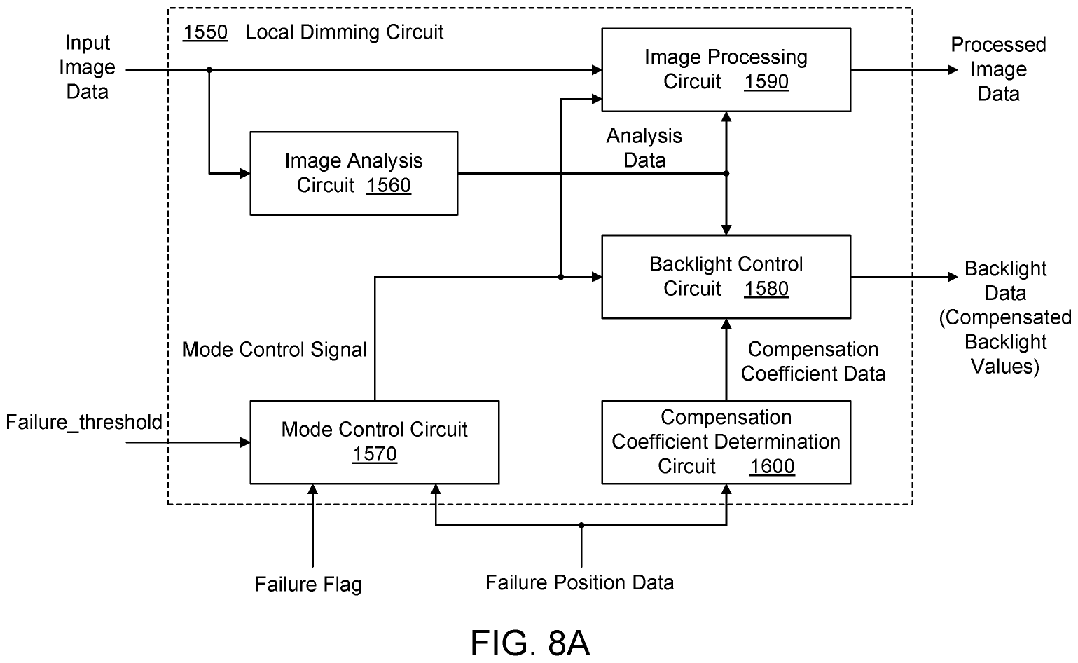

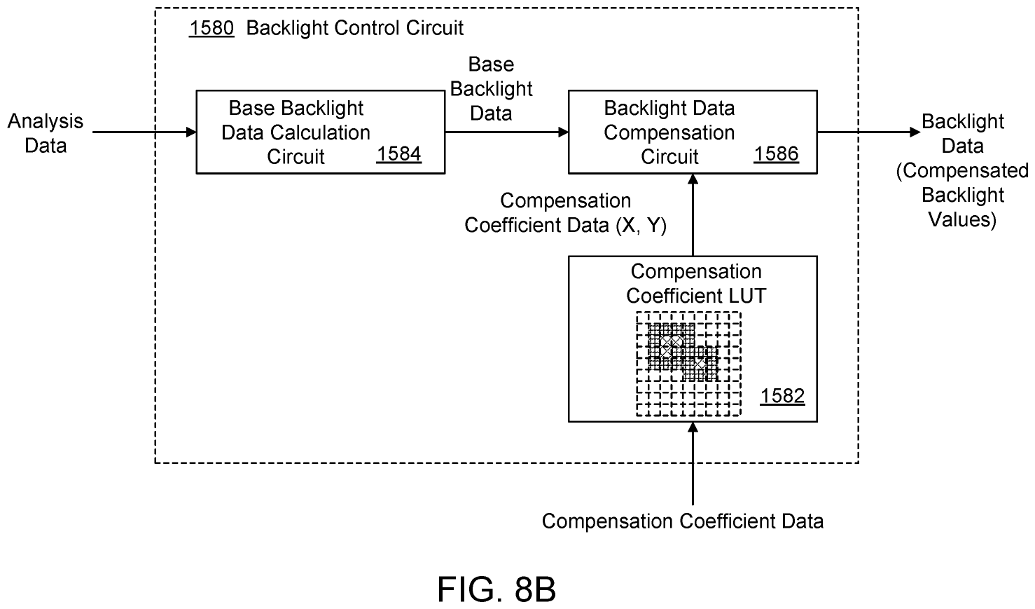

FIG. 8A shows an example configuration of a local dimming circuit 1550 configured to compensate for a failure of one or more light sources 210 by increasing luminance levels of the light sources 210 adjacent to the failed light sources 210, according to one or more embodiments. The local dimming circuit 1550 may be an embodiment of the local dimming circuit 550 shown in FIG. 1 or an embodiment of the local dimming circuit 1350 shown in FIG. 6. In the embodiment shown in FIG. 8A, the local dimming circuit 1550 is configured to receive the input image data from the host 2000 (shown in FIG. 1) and the failure flag from the backlight driver 600. The local dimming circuit 1550 is configured to process the input image data to generate output image data, and generate the backlight data to control the luminance levels of the respective light sources 210 of the backlight device 200. In one or more embodiments, the local dimming circuit 1550 includes an image analysis circuit 1560, a mode control circuit 1570, a backlight control circuit 1580, an image processing circuit 1590, and a compensation coefficient determination circuit 1600.

The image analysis circuit 1560 is configured to analyze the input image data to generate analysis data in a manner similar to the image analysis circuit 560 described in relation to FIG. 3. In one implementation, the image analysis circuit 1560 may be configured to calculate the APLs of the respective zones 110 of the display panel 100 based on the input image data, and the analysis data may include the APLs of the respective zones 110.

The mode control circuit 1570 is configured to control the operating mode of the local dimming circuit 1550 in response to the failure flag and the failure position data received from the backlight driver 600 (shown in FIG. 1). As described above, the failure position data may indicate the position(s) or arrangement of the failed light source(s) 210. In one or more embodiments, the mode control circuit 1570 may be configured to determine the number of failed light sources 210 based on the failure flag and the failure position data. The mode control circuit 1570 may further be configured to place the local dimming circuit 1550 in the local dimming mode, in which the local dimming function is implemented, when no light sources 210 experience a failure. The mode control circuit 1570 may further be configured to place the local dimming circuit 1550 in the failure mode when the number of failed light sources 210 is greater than a predetermined threshold number. The mode control circuit 1570 may further be configured to place the local dimming circuit 1550 in a “second” local dimming mode when the number of failed light sources 210 is non-zero and less than the predetermined threshold number. The “second” local dimming mode is an operating mode in which the local dimming function is enabled while the failure of the light source(s) 210 is compensated for by increasing the luminance levels of the light sources 210 adjacent to the failed light source(s) 210. The mode control circuit 1570 is configured to notify the image processing circuit 1590 and the backlight control circuit 1580 of the operating mode of the local dimming circuit 1550 by a mode control signal.

The image processing circuit 1590 is configured to process the input image data based on the analysis data received from the image analysis circuit 1560 to generate processed image data in a manner similar to the image processing circuit 590 described in relation to FIG. 3. The processed image data may be provided to the display drivers 300 (shown in FIG. 1), which are configured to drive the display panel 100 based on the processed image data. The image processing performed by the image processing circuit 1590 may include a gamma transformation. In one implementation, the gamma transformation may convert input graylevels to gamma-transformed graylevels for the respective pixels in accordance with gamma curves determined for the respective pixels based on the APLs described in the analysis data. The input greylevels of the respective pixels may be generated by performing desired processing on the greylevels described in the input image data. The gamma-transformed graylevels of the respective pixels are used to determine the graylevels of the respective pixels described in the processed image data. The gamma-transformed graylevels determined by the gamma transformation may be used without modification as the graylevels described in the processed image data. Details of determining the gamma curves are described in detail later. The processing performed by the image processing circuit 1590 may further include various image processes other than the gamma transformation, such as color adjustment, demura correction, deburn correction, image scaling, or other image processes.

In one or more embodiments, the image processing circuit 1590 may be further configured to determine, in response to the local dimming circuit 1550 entering the failure mode, a compensated gamma curve for pixels located in the zone(s) 110 corresponding to the failed light source(s) 210 to increase the luminance levels of the pixels in that zone 110 as described in relation to FIG. 4. In such embodiments, the image processing circuit 1590 may be configured to perform a gamma transformation on the input greylevels of the pixels located in the zone(s) 110 corresponding to the failed light source(s) 210 in accordance with the compensated gamma curve.

The compensation coefficient determination circuit 1600 is configured to generate compensation coefficient data based on the failure position data received from the backlight driver 600 (shown in FIG. 1). As discussed in relation to FIG. 1, the failure position data may indicate the arrangement or position(s) of the failed light source(s) 210. The compensation coefficient data includes compensation coefficients that indicate the amounts by which the luminance levels of the light sources 210 adjacent to the failed light source(s) 210 are to be increased. In one implementation, the compensation coefficients for the light sources 210 adjacent to the failed light source(s) 210 may be determined to be a non-zero value. The compensation coefficients for the light sources 210 adjacent to none of the failed light source(s) 210 may be determined to be zero.

The backlight control circuit 1580 is configured to generate backlight data based on the analysis data received from the image analysis circuit 1560 and the compensation coefficient data received from the compensation coefficient determination circuit 1600. FIG. 8B shows an example configuration of the backlight control circuit 1580, according to one or more embodiments. In the shown embodiment, the backlight control circuit 1580 includes a compensation coefficient lookup table (LUT) 1582, a base backlight data calculation circuit 1584, and a backlight data compensation circuit 1586.

The compensation coefficient LUT 1582 is configured to store the compensation coefficient data received from the compensation coefficient determination circuit 1600. As described above, the compensation coefficient data includes the compensation coefficients determined for the respective light sources 210. The compensation coefficient LUT 1582 is configured to provide the stored compensation coefficient data to the backlight data compensation circuit 1586. For example, the compensation coefficient LUT 1582 may be configured such that the compensation coefficients determined for the respective light sources 210 are addressable by the coordinates of the respective light sources 210, which is indicated by “(X, Y)” in FIG. 8B.

The base backlight data calculation circuit 1584 is configured to generate base backlight data based on the analysis data received from the image analysis circuit 1560 (shown in FIG. 8A). The base backlight data includes base backlight values calculated for the respective light sources 210. In embodiments where the analysis data includes the APLs of the respective zones 110, the base backlight data calculation circuit 1584 may be configured to calculate the base backlight values for the respective light sources 210 based on the APLs of the zones 110 corresponding to the respective light sources 210. The base backlight data calculation circuit 1584 is further configured to provide the base backlight data thus generated to the backlight data compensation circuit 1586.

The backlight data compensation circuit 1586 is configured to generate backlight data by modifying the base backlight data received from the base backlight data calculation circuit 1584 based on the compensation coefficient data received from the compensation coefficient LUT 1582. The backlight data may include compensated backlight values for the respective light sources 210. Since the compensation values for the light sources 210 adjacent to no failed light sources 210 are zero, the compensated backlight values for the light sources 210 adjacent to no failed light sources 210 are equal to the base backlight values for those light sources 210. Meanwhile, the compensated backlight values for the light sources 210 adjacent to at least one failed light source 210 are generated by modifying the base backlight values for those adjacent light sources 210 based on the compensation coefficients determined for those light sources 210. In one implementation, the backlight data, which may include the compensated backlight values, is provided to the backlight driver 600 to control the luminance levels of the respective light sources 210. The compensated backlight values for the respective light sources 210 may indicate specified luminance levels of the respective light sources 210, and the luminance levels of the respective light sources 210 may be controlled based on the compensated backlight values for the respective light sources 210.

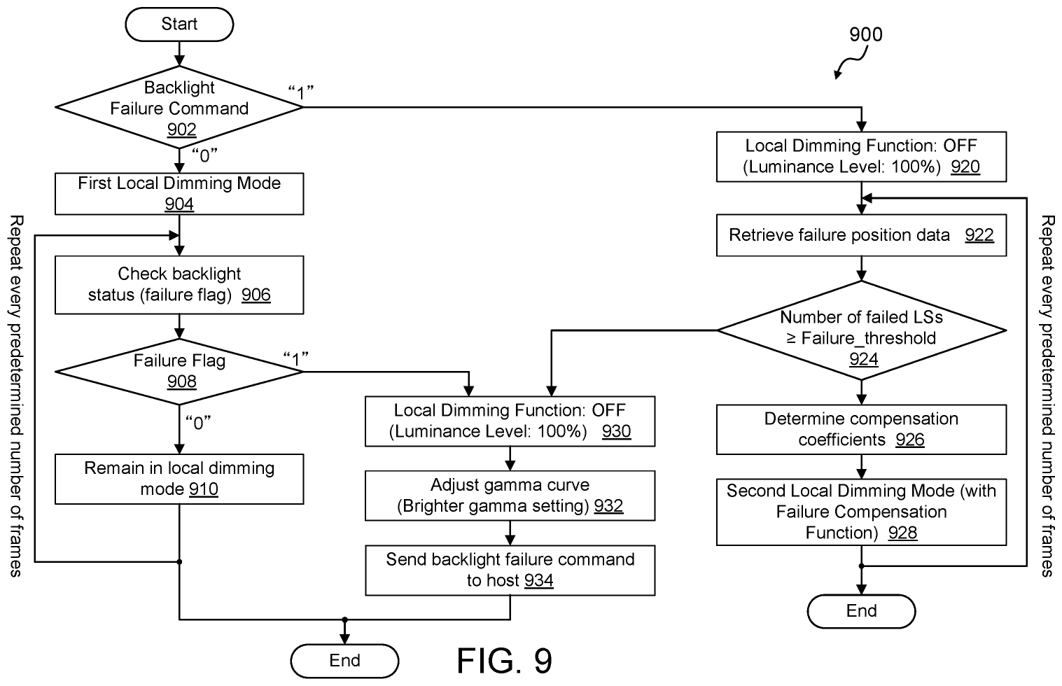

FIG. 9 shows an example method 900 which implements a fail-safe function for avoiding partial loss of display when a failure of one or more light sources 210 occurs while compensating for a failure of one or more light sources 210 by increasing the luminance levels of the light sources 210 adjacent to the failed light sources 210, according to one or more embodiments. It will be recognized that, except where otherwise apparent, the following steps may be performed in any suitable order, and that the method 900 may be performed in any suitable environment.

As described in relation to FIG. 5, the host 2000 (shown in FIG. 1) may have information regarding the failure of the light sources 210 of the backlight device 200 prior to the startup of the display device 1000. Upon startup of the display device 1000, the host 2000 may send a backlight failure command to the local dimming circuit 1550 if the host 2000 is aware that one or more light sources 210 have been failed.

When the local dimming circuit 1550 does not receive the backlight failure command during the startup in step 902, the local dimming circuit 1550 enters a first local dimming mode in step 904. It is noted that the first local dimming mode is an operating mode in which the local dimming function is implemented but the compensation for the light source failure is not performed. The backlight control circuit 1580 implements the local dimming function in the first local dimming mode to individually control the luminance levels of the respective light sources 210 of the backlight device 200 based on the analysis data received from the image analysis circuit 1560. The process then proceeds to step 906.

In step 906, the local dimming circuit 1550 checks the status of the backlight device 200 based on whether the local dimming circuit 1550 receives the failure flag from the backlight driver 600. As long as the local dimming circuit 1550 does not receive the failure flag, the local dimming circuit 1550 remains in the first local dimming mode in step 910. The local dimming circuit 1550 may check the status of the backlight device 200 every predetermined number of frames as long as the local dimming circuit 1550 remains in the first local dimming mode.

When a failure of one or more light sources 210 occurs during operation, the backlight driver 600 sends the failure flag to the local dimming circuit 1550 in step 908, and the process proceeds to step 930.

In step 930, the local dimming circuit 1550 enters the failure mode, thereby disabling the local dimming function. In addition, the backlight control circuit 1580 of the local dimming circuit 1550 adjusts the luminance levels of the non-failed light sources 210 to a predetermined luminance level (e.g., 100% or the maximum allowed luminance level) by the backlight data. The process then proceeds to step 932.

In step 932, the image processing circuit 1590 of the local dimming circuit 1550 adjusts the gamma curve used for the gamma transformation for the pixels located in the zone(s) 110 corresponding to the failed light source(s) 210 as in steps 422 and 432, which are described in relation to FIG. 5. In one implementation, the image processing circuit 1590 determines a compensated gamma curve for the pixels located in the zone(s) 110 corresponding to the failed light source(s) 210 and performs the gamma transformation for the pixels located in the zone(s) 110 corresponding to the failed light source(s) 210 in accordance with the compensated gamma curve. As discussed in relation to step 422 shown in FIG. 5, the compensated gamma curve may be determined such that the gamma value of the compensated gamma curve is a predetermined value equal to or close to 1.0 to increase the luminance levels of the pixels located in the zone(s) 110 corresponding to the failed light source(s) 210. The process then proceeds to step 934.

In step 934, the local dimming circuit 1550 sends a backlight failure command to the host 2000 to thereby notify the host 2000 of the occurrence of the failure of one or more light sources 210. This causes the host 2000 to be aware of the failure of one or more light sources 210. At the next startup of the display device, the host 2000 may send a backlight failure command to the local dimming circuit 1550 to notify the local dimming circuit 550 of the failure of one or more light sources 210.

If the local dimming circuit 1550 receives the backlight failure command during the startup in step 902 (e.g., if one or more light sources 210 have failed), the process proceeds to step 920.

In step 920, the local dimming circuit 1550 disables the local dimming function. Further, the backlight control circuit 1580 of the local dimming circuit 1550 adjusts the luminance levels of the non-failed light sources 210 to a predetermined luminance level, e.g., 100% or the maximum allowed luminance level, by the backlight data. In one implementation, the backlight control circuit 1580 may determine the backlight values for the non-failed light sources 210 contained in the backlight data to be the value corresponding to the maximum allowed luminance level to cause the non-failed light sources 210 to emit light at the maximum allowed luminance level. The process then proceeds to step 922.

In step 922, the local dimming circuit 1550 retrieves the failure position data from the backlight driver 600. It is noted that the failure position data may indicate the arrangement or position(s) of the failed light source(s) 210. The process then proceeds to step 924.

In step 924, the mode control circuit 1570 of the local dimming circuit 1550 determines the number of the failed light sources 210 based on the failure position data. If the number of the failed light sources 210 is greater than or equal to a predetermined threshold number, the local dimming circuit 1550 enters the failure mode and the process proceeds to step 930. If the number of the failed light sources 210 is less than the predetermined threshold number, the process proceeds to step 926.

In step 926, the compensation coefficient determination circuit 1600 determines the compensation coefficients for the respective light sources 210 based on the failure position data, which may indicate the arrangement or position(s) of the failed light source(s) 210. In one implementation, the compensation coefficients for the light sources 210 adjacent to at least one failed light source 210 may be determined to be a non-zero value. The compensation coefficients for the light sources 210 adjacent to no failed light sources 210 may be determined to be zero. The determined compensation coefficients are provided to the backlight control circuit 1580 and stored in the compensation coefficient LUT 1582 of the backlight control circuit 1580. The process then proceeds to step 928.

In step 928, the local dimming circuit 1550 enters a second local dimming mode. It is noted that the second local dimming mode is an operating mode in which the local dimming function is implemented with the light source failure compensation. In the second local dimming mode, the backlight data compensation circuit 1586 of the backlight control circuit 1580 generates compensated backlight values for the respective light sources 210 by modifying the base backlight values for the respective light sources 210 based on the compensation coefficients for the respective light sources 210. The compensated backlight values for the respective light sources 210 are provided to the backlight driver 600, and the backlight driver 600 controls the luminance levels of the respective light sources 210 based on the compensated backlight values for the respective light sources 210.

The above-described steps 922, 924, 926, and 928 may be repeated every predetermined number of frames as long as the number of the failed light sources 210 is less than the predetermined threshold number.

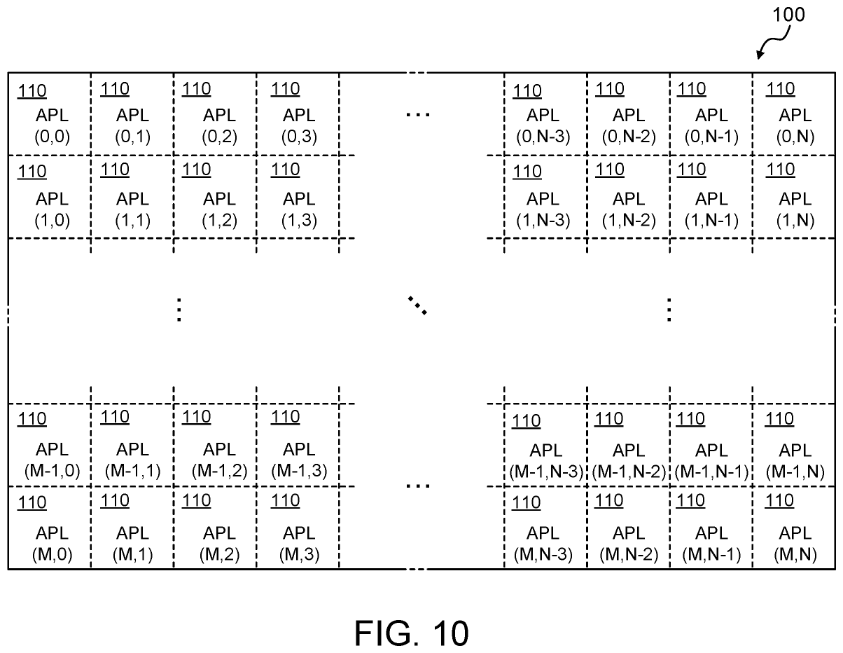

As described above, the gamma transformation performed by the image processing circuit 1590 (shown in FIG. 8A) may be based on gamma curves determined for the respective pixels based on the APLs described in the analysis data generated by the image analysis circuit 1560. FIG. 10 shows an example of the APLs of the respective zones 110 of the display panel 100, according to one or more embodiments. In FIG. 10, APL (i, j) indicates the APL of the zone 110 in the (i+1)-th row from the top and the (j+1)-th column from the left, where i is a natural number between 0 and M−1, inclusive, and j is a natural number between 0 and N−1, inclusive. The following describes an example method for determining the gamma values of the gamma curves used for the gamma transformation for the respective pixels, according to one or more embodiments.

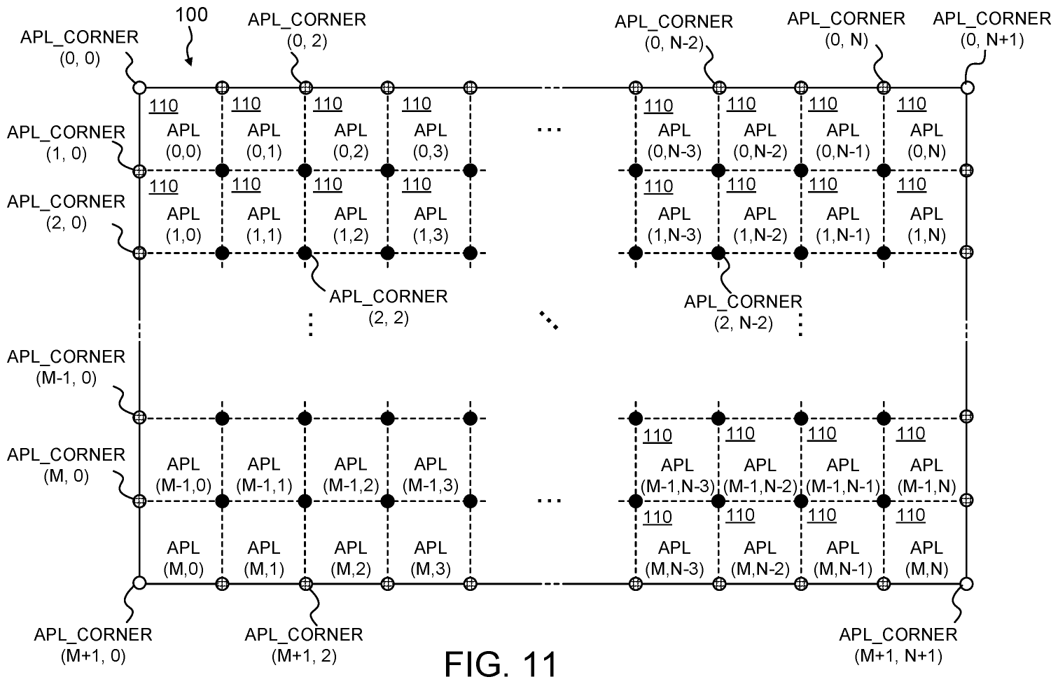

Referring to FIG. 11, the black circles, hatched circles, and white circles indicate the corners of the respective zones 110, which are hereinafter referred to as “zone corners”. In the embodiment shown in FIG. 11, the zone corners are arranged in M+2 rows and N+2 columns on the display panel 100. In one or more embodiments, the image processing circuit 1590 may be configured to calculate “zone corner APLs” for the respective zone corners from the APLs of the respective zones 110. The “zone corner APL” of a zone corner represents the APL of a region around that zone corner. In the embodiment shown in FIG. 11, APL_CORNER (i, j) indicates the zone corner APL of the zone corner in the (i+1)-th row from the top and (j+1)-th column from the left, where i is a natural number between 0 and M, inclusive, and j is a natural number between 0 and N, inclusive.

It should be noted that the zone corners that are not positioned at the four corners of the display panel 100 are shared by multiple zones 110, more specifically, two or four zones 110. In one implementation, the zone corner APL of a zone corner of interest that is not positioned at the four corners of the display panel 100 is determined to be the average of the APLs of the respective zones 110 that share the zone corner of interest. Meanwhile, the zone corner APL of the zone corner positioned at each corner of the display panel 100 is determined to be equal to the APL of the zone 110 at that corner of the display panel 100.

More specifically, in one or more embodiments, the “zone corners” may be classified into the following three types: (1) zone corners positioned at the corners of the display panel 100, indicated by the white circles; (2) zone corners positioned at the edges of the display panel 100, indicated by the hatched circles; and (3) other zone corners, indicated by the black circles, and the determination of the zone corner APLs of the respective zone corners may depend on the respective zone corner types, as described below.

### (1) Zone Corners Positioned at Corner of Display Panel

The zone corner APLs of the zone corners positioned at the four corners of the display panel 100 may be determined according to the following expressions (1a) to (1d):

$$APL\_CORNER ( 0 , 0 ) = APL ( 0 , 0 ) , \qquad ( 1 a )$$

$$APL\_CORNER ( 0 , N + 1 ) = APL ( 0 , N ) , \qquad ( 1 b )$$

$$APL\_CORNER ( M + 1 , 0 ) = APL ( M , 0 ) , and \qquad ( 1 c )$$

$$APL\_CORNER ( M + 1 , N + 1 ) = APL ( M , N ) . \qquad ( 1 d )$$

### (2) Zone Corners Positioned at Edges of Display Panel

The zone corner APLs of the zone corners positioned at the four edges of the display panel 100 may be determined according to the following expressions (2a) to (2d):

$$APL\_CORNER ( 0 , q ) = \{ APL ( 0 , q - 1 ) + APL ( 0 , q ) \} / 2 , \qquad ( 2 a )$$

$$APL\_CORNER ( p , 0 ) = \{ APL ( p - 1 , 0 ) + APL ( p , 0 ) \} / 2 , \qquad ( 2 b )$$

$$APL\_CORNER ( M + 1 , q ) = \{ APL ( M , q - 1 ) + APL ( M , q ) \} / 2 , and \qquad ( 2 c )$$

$$APL\_CORNER ( p , N + 1 ) = \{ APL ( p - 1 , N ) + APL ( p , N ) \} / 2 , \qquad ( 2 d )$$

where p is a natural number between 1 and M, inclusive, and q is a natural number between 1 and N, inclusive.

### (3) Other Zone Corners Positioned at Edges of Display Panel

The zone corner APLs of other zone corners, which are positioned in the inner portion of the display panel 100, may be determined according to the following expressions (3):

$$APL\_CORNER ( p , q ) = \{ APL ( p - 1 , q - 1 ) + APL ( p - 1 , q ) + APL ( p , q - 1 ) + APL ( p , q ) \} / 4. \qquad ( 3 )$$

In one or more embodiments, the image processing circuit 1590 may be further configured to calculate “pixel APLs” for the respective pixels from the zone corner APLs of the respective zone corners. The pixel APL for a pixel represents the APL of a region around that pixel. In one implementation, the pixel APL for a pixel located in a zone 110 is calculated by interpolating the zone corner APLs determined for the corners of that zone 110 depending on the position of the pixel in that zone 110.

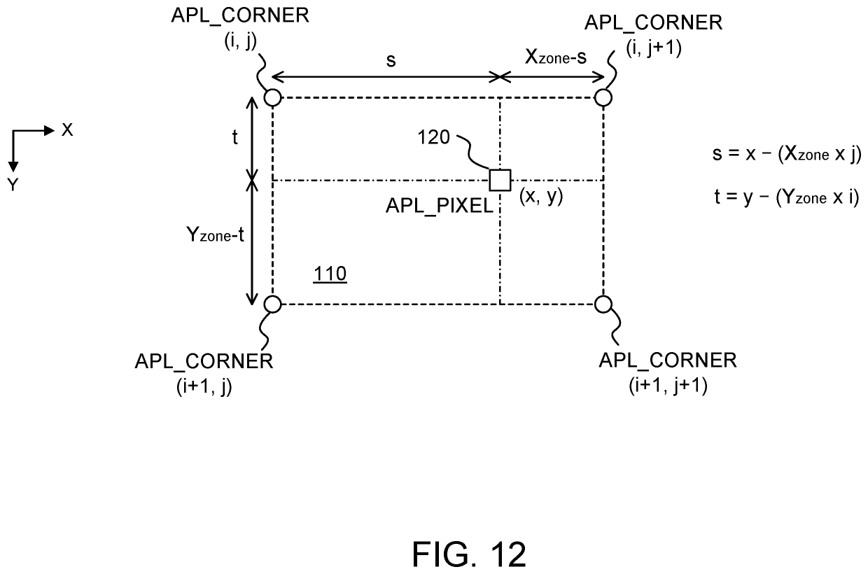

FIG. 12 shows an example calculation of the pixel APL for a pixel 120 located in a zone 110 in the (i+1)-th row and the (j+1)-th column, according to one or more embodiments, where i is a natural number between 0 and M, inclusive, j is a natural number between 0 and N, inclusive, and (x, y) are the X and Y coordinates of the pixel 120. In the shown embodiment, the zone corner APLs determined for the corners of this zone 110 are APL_CORNER (i, j), APL_CORNER (i, j+1), APL_CORNER (i+1, j), and APL_CORNER (i+1, j+1), respectively. In one or more embodiments, the pixel APL for the pixel 120 located at (x, y) may be calculated according to the following expression (4):

$$APL\_PIXEL ( x , y ) = \frac{Yzone - t}{Yzone} \cdot \qquad ( 4 )$$

$$\frac{APL\_CORNER ( i , j + 1 ) \cdot s + APL\_CORNER ( i , j ) \cdot ( Xzone - s )}{Xzone} +$$

$$\frac{t}{Yzone} \cdot \frac{\begin{matrix}APL\_CORNER ( i + 1 , j + 1 ) \cdot s + \\ APL\_CORNER ( i + 1 , j ) \cdot ( Xzone - s )\end{matrix}}{Xzone} ,$$

where APL_PIXEL (x, y) is the pixel APL of the pixel 120 at (x, y), s and t are parameters defined by the following expressions (5a) and (5b):

$$s = x - Xzone \cdot j , \qquad ( 5 a )$$

$$t = y - Yzone \cdot i , \qquad ( 5 b )$$

Xzone is the horizontal width of each zone 110, and Yzone is the vertical height of each zone 110. The pixel APL for each pixel of the display panel 100 may be calculated in accordance with expression (4).

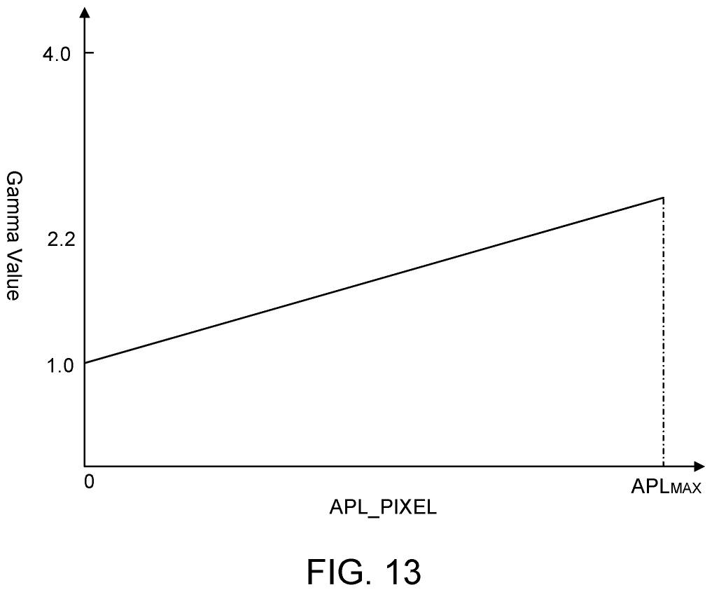

Referring to FIG. 13, in one or more embodiments, the gamma value of the gamma curve used for the gamma transformation for each pixel may be determined based on the pixel APL calculated for that pixel. In one implementation, the gamma value of the gamma curve used for the gamma transformation for each pixel increases as the pixel APL of that pixel increases. In other words, the smaller the pixel APL of a pixel of interest is, the smaller the gamma value of the gamma curve used for the gamma transformation for that pixel is. While FIG. 13 shows that the gamma curve used for the gamma transformation increases linearly with the pixel APL, the gamma curve used for the gamma transformation may increase non-linearly with the pixel APL. The image processing circuit 1590 may be configured to perform the gamma transformation on the input graylevel of each pixel in accordance with the gamma curve defined by the gamma value determined based on the pixel APL of that pixel.

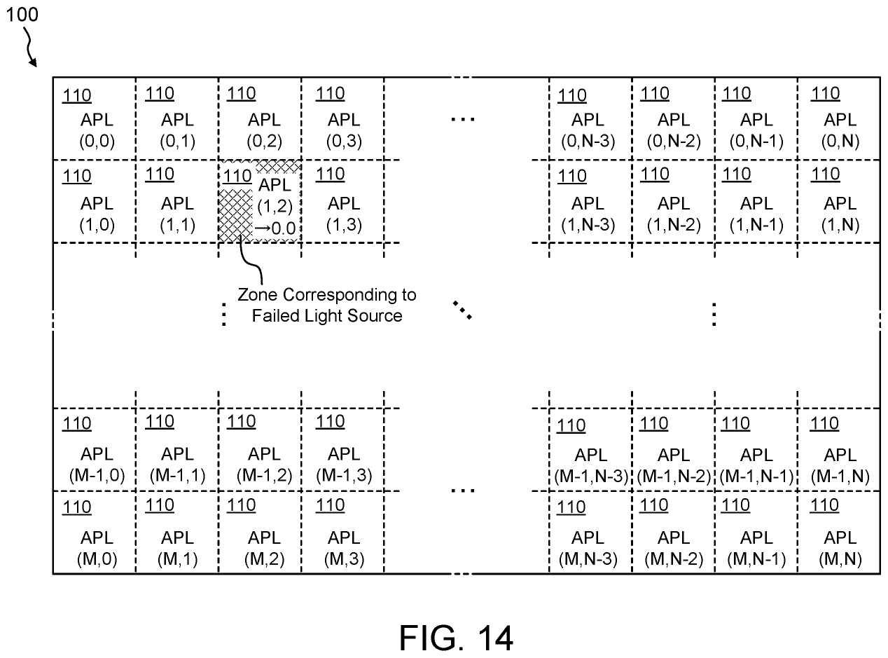

In one or more embodiments, the image processing circuit 1590 may be further configured to, in the second local dimming mode, adjust the gamma curves for the pixels located in the zone(s) 110 corresponding to the failed light source(s) 210 to increase the luminance levels of the pixels located in that zone(s) 110. Referring to FIG. 14, the adjustment of the gamma curves for the pixels located in the zone 110 corresponding to a failed light source 210 may be accomplished by defining a predetermined hypothetical APL for the zone 110 corresponding to the failed light source 210 and using the hypothetical APL to calculate the zone corner APLs and the pixel APLs in place of the APL of that zone 110 calculated from the input image data. This results in that the gamma values of the gamma curves used for the gamma transformation for the pixels located in the zone 110 corresponding to the failed light source 210 are determined based on the hypothetical APL. In such embodiments, the smaller the hypothetical APL is, the smaller are the gamma values of the gamma curves used for the gamma transformation for the pixels located in the zone 110 corresponding to the failed light source 210. Accordingly, the luminance levels of the pixels located in the zone 110 corresponding to the failed light source 210 can be increased by setting the hypothetical APL to a small value, such as zero. In one implementation, the hypothetical APL may be zero. In the embodiment shown in FIG. 14, in which the light source 210 corresponding to the zone 110 in the second row and the third column is assumed to have failed, the APL (1, 2) of that zone 110 is set to 0.0 regardless of the input image data. This will increase the luminance levels of the pixels located in that zone 110 to compensate for the failure of the light source 210 corresponding to that zone 110.

In other embodiments, the adjustment of the gamma curves for the pixels located in the zone 110 corresponding to a failed light source 210 may be accomplished by modifying the APL of the zone 110 corresponding to the failed light source 210 and using the modified APL to calculate the zone corner APLs and the pixel APLs in place of the APL of that zone 110 calculated from the input image data. This results in that the gamma values of the gamma curves used for the gamma transformation for the pixels located in the zone 110 corresponding to the failed light source 210 are determined based on the modified APL. In such embodiments, the smaller the modified APL is, the smaller the gamma values of the gamma curves used for the gamma transformation for the pixels located in the zone 110 corresponding to the failed light source 210 are. Accordingly, the luminance levels of the pixels located in the zone 110 corresponding to the failed light source 210 can be increased by determining the modified APL to be smaller than the APL for the zone 110 corresponding to the failed light source 210 calculated based on the input image data. In one implementation, the modified APL may be calculated by subtracting a positive value from the APL for the zone 110 corresponding to the failed light source 210.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Exemplary embodiments are described herein. Variations of those exemplary embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A display device, comprising:
a backlight device comprising a plurality of light sources configured to illuminate a display panel;
a local dimming circuit configured to:
individually control luminance levels of the plurality of light sources based on first input image data in a first local dimming mode;
enter a failure mode in response to a failure of at least one of the plurality of light sources; and
control luminance levels of others of the plurality of light sources to a predetermined luminance level in the failure mode.

2. The display device of claim 1, wherein the predetermined luminance level is a maximum allowed luminance level for the plurality of light sources.

3. The display device of claim 1, wherein the local dimming circuit is further configured to:
determine, in response to the local dimming circuit entering the failure mode, a compensated gamma curve for pixels in a zone corresponding to a failed one of the plurality of light sources to increase luminance levels of the pixels in the zone; and
in the failure mode, perform a gamma transformation on second input image data to generate second output image data used to drive the display panel, wherein the gamma transformation for pixel data of pixels in the zone corresponding to the failed one of the plurality of light sources is based on the compensated gamma curve.

4. The display device of claim 1, wherein the local dimming circuit is further configured to:
enter a second local dimming mode in response to a number of failed ones of the plurality of light sources being non-zero and less than a predetermined number;
in the second local dimming mode,
determine base backlight values for the respective light sources based on second input image data, wherein the base backlight values for the respective light sources include:
a first base backlight value for a failed one of the light sources; and
second base backlight values for adjacent ones of the light sources, the adjacent ones of the light sources being adjacent to the failed one of the light sources;
determine compensated backlight values for the adjacent ones of the light sources based on the second base backlight values and an arrangement of the failed ones of the plurality of light sources; and
control luminance levels of the adjacent ones of the light sources based on the compensated backlight values.

5. The display device of claim 4, wherein determining the compensated backlight values comprises modifying the second base backlight values based on the first base backlight value to increase the luminance levels of the adjacent ones of the light sources.

6. The display device of claim 1, wherein the local dimming circuit is further configured to:
enter a second local dimming mode in response to a number of failed ones of the plurality of light sources being a non-zero and less than a predetermined threshold number;
in the second local dimming mode,
calculate a first average picture level (APL) of a first zone corresponding to a non-failed one of the light sources based on second input image data;
determine a first gamma curve for a first pixel in the first zone based on the first APL;
perform a gamma transformation on a first graylevel of the first pixel described in the second input image data based on the first gamma curve to determine a first gamma-transformed graylevel used to drive the first pixel;
define a predetermined hypothetical APL for a second zone corresponding to a failed one of the light sources;
determine a second gamma curve for a second pixel in the second zone based on the predetermined hypothetical APL; and
perform a gamma transformation on a second graylevel of the second pixel described in the second input image data based on the second gamma curve to determine a second gamma-transformed graylevel used to drive the second pixel.

7. The display device of claim 6, wherein the smaller the first APL is, the smaller a first gamma value of the first gamma curve is, and
wherein the predetermined hypothetical APL is zero.

8. The display device of claim 1, wherein the local dimming circuit is further configured to:
enter a second local dimming mode in response to a number of failed ones of the plurality of light sources being a non-zero and less than a predetermined number;
in the second local dimming mode,
calculate a first APL of a first zone corresponding to a non-failed one of the light sources based on second input image data;
determine a first gamma curve for a first pixel in the first zone based on the first APL;
perform a gamma transformation on a first graylevel of the first pixel described in the second input image data based on the first gamma curve to determine a first gamma-transformed graylevel used to drive the first pixel;
calculate a second APL of a second zone corresponding to a failed one of the light sources based on second input image data;
determine a modified APL for the second zone by modifying the second APL such that the modified APL is less than the second APL;
determine a second gamma curve for a second pixel in the second zone based on the modified APL; and
perform a gamma transformation on a second graylevel of the second pixel described in the second input image data based on the second gamma curve to determine a second gamma-transformed graylevel used to drive the second pixel.

9. The display device of claim 8, wherein the modified APL for the second zone is determined to be less than the second APL,
wherein the smaller the first APL is, the smaller a first gamma value of the first gamma curve is, and
wherein the smaller the modified APL is, the smaller a second gamma value of the second gamma curve is.

10. A display driver, comprising:
a local dimming circuit configured to:
individually control luminance levels of a plurality of light sources of a backlight device based on first input image data in a first local dimming mode, wherein the plurality of light sources are configured to illuminate a display panel;
enter a failure mode in response to a failure of at least one of the plurality of light sources; and
control luminance levels of others of the plurality of light sources to a predetermined luminance level in the failure mode; and
a driver circuit configured to drive the display panel based on the first input image data.

11. The display driver of claim 10, wherein the predetermined luminance level is a maximum allowed luminance level for the plurality of light sources.

12. The display driver of claim 10, wherein the local dimming circuit is further configured to:
determine, in response to the local dimming circuit entering the failure mode, a compensated gamma curve for pixels in a zone corresponding to a failed one of the plurality of light sources to increase luminance levels of the pixels in the zone; and
in the failure mode, perform a gamma transformation on second input image data to generate second output image data used to drive the display panel, wherein the gamma transformation for pixel data of pixels in the zone corresponding to the failed one of the plurality of light sources is based on the compensated gamma curve.

13. The display driver of claim 10, wherein the local dimming circuit is further configured to:
enter a second local dimming mode in response to a number of failed ones of the plurality of light sources being non-zero and less than a predetermined threshold number;
in the second local dimming mode,
determine base backlight values for the respective light sources based on second input image data, wherein the base backlight values for the respective light sources include:
a first base backlight value for a failed one of the light sources; and
second base backlight values for adjacent ones of the light sources, the adjacent ones of the light sources being adjacent to the failed one of the light sources;
determine compensated backlight values for the adjacent ones of the light sources based on the second base backlight values and an arrangement of the failed ones of the plurality of light sources; and
control luminance levels of the adjacent ones of the light sources based on the compensated backlight values.

14. The display driver of claim 13, wherein determining the compensated backlight values comprises modifying the second base backlight values based on the first base backlight value to increase the luminance levels of the adjacent ones of the light sources.

15. The display driver of claim 10, wherein the local dimming circuit is further configured to:
enter a second local dimming mode in response to a number of failed ones of the plurality of light sources being a non-zero and less than a predetermined number;
in the second local dimming mode,
calculate a first average picture level (APL) of a first zone corresponding to a non-failed one of the light sources based on second input image data;
determine a first gamma curve for a first pixel in the first zone based on the first APL;
perform a gamma transformation on a first graylevel of the first pixel described in the second input image data based on the first gamma curve to determine a first gamma-transformed graylevel used to drive the first pixel;
define a predetermined hypothetical APL for a second zone corresponding to a failed one of the light sources;
determine a second gamma curve for a second pixel in the second zone based on the predetermined hypothetical APL; and
perform a gamma transformation on a second graylevel of the second pixel described in the second input image data based on the second gamma curve to determine a second gamma-transformed graylevel used to drive the second pixel.

16. The display driver of claim 15, wherein the smaller the first APL is, the smaller a first gamma value of the first gamma curve is, and
wherein the predetermined hypothetical APL is zero.

17. The display driver of claim 10, wherein the local dimming circuit is further configured to:
enter a second local dimming mode in response to a number of failed ones of the plurality of light sources being a non-zero and less than a predetermined number;
in the second local dimming mode,
calculate a first APL of a first zone corresponding to a non-failed one of the light sources based on second input image data;
determine a first gamma curve for a first pixel in the first zone based on the first APL;
perform a gamma transformation on a first graylevel of the first pixel described in the second input image data based on the first gamma curve to generate a first gamma-transformed graylevel used to drive the first pixel;
calculate a second APL of a second zone corresponding to a failed one of the light sources based on second input image data;
determine a modified APL for the second zone by modifying the second APL such that the modified APL is less than the second APL;
determine a second gamma curve for a second pixel in the second zone based on the modified APL; and
perform a gamma transformation on a second graylevel of the second input image data based on the second gamma curve to determine a second gamma-transformed graylevel used to drive the second pixel.

18. A method, comprising:
placing a local dimming circuit in a first local dimming mode;
individually controlling, by the local dimming circuit in the first local dimming mode, luminance levels of a plurality of light sources of a backlight device based on first input image data, wherein the plurality of light sources are configured to illuminate a display panel;
placing the local dimming circuit in a failure mode in response to a failure of at least one of the plurality of light sources; and
controlling, by the local dimming circuit in the failure mode, luminance levels of others of the plurality of light sources to a predetermined luminance level.

19. The method of claim 18, further comprising:
determining, by the local dimming circuit in the failure mode, a compensated gamma curve for pixels in a zone corresponding to a failed one of the plurality of light sources to increase luminance levels of the pixels in the zone; and
performing, by the local dimming circuit in the failure mode, a gamma transformation on second input image data to generate second output image data used to drive the display panel, wherein the gamma transformation for pixel data of pixels in the zone corresponding to the failed one of the plurality of light sources is based on the compensated gamma curve.

20. The method of claim 18, wherein the local dimming circuit is further configured to:
placing the local dimming circuit into a second local dimming mode in response to a number of failed ones of the plurality of light sources being non-zero and less than a predetermined threshold number;
determining base backlight values for the respective light sources based on second input image data, wherein the base backlight values for the respective light sources include:
a first base backlight value for a failed one of the light sources; and
second base backlight values for adjacent ones of the light sources, the adjacent ones of the light sources being adjacent to the failed one of the light sources;
determining compensated backlight values for the adjacent ones of the light sources based on the second base backlight values and an arrangement of the failed ones of the plurality of light sources; and
controlling luminance levels of the adjacent ones of the light sources based on the compensated backlight values.
